(19) United States
(12) Patent Application Publication
(10) Pub. No.: US 2022/0070002 A1
(43) Pub. Date: Mar. 3, 2022

(54) MULTI-SERVICE SCEP-CERTIFICATE BASED AUTHENTICATION

(71) Applicant: VMware, Inc., Palo Alto, CA (US)

(72) Inventors: Stephen Louis Turner, Atlanta, GA (US); Simon Brooks, Palo Alto, CA (US)

(21) Appl. No.: 17/004,347

(22) Filed: Aug. 27, 2020

(51) Int. Cl. H04L 9/32; H04L 9/08

(52) U.S. Cl. CPC H04L 9/3228; H04L 9/3213; H04L 9/3268; H04L 9/0825

(57) ABSTRACT

Disclosed are various embodiments for implementing an multi-service simple certificate enrollment protocol (SCEP) based authentication system. First, a computing device can send a certificate signing request (CSR) for a token signing certificate to a simple certificate enrollment protocol (SCEP) server. Then the computing device can receive the token signing certificate from the SCEP server. Next, the computing device can generate a authentication token that authenticates a user of the computing device with an authentication service. Subsequently, the computing device can sign the authentication token with the token signing certificate to create a signed authentication token. Finally, the computing device can send the signed authentication token to the authentication service to authenticate the user of the computing device with the authentication service.

### BACKGROUND

Public key cryptographic authentication credentials have typically been managed by a central certificate authority (CA). This allowed for third-parties to trust the certificates used by client devices, knowing they had been created and validated by a trusted authority or service. However, centralized control of the generation and distribution of security credentials and certificates created a single point of failure from both a performance perspective (e.g., the CA could only handle a limited number of requests per unit of time) and from a security perspective (e.g., a breach of the CA could lead to potential compromise of all devices relying on the CA).

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is a flowchart illustrating one example of functionality implemented as portions of an application executed in a computing environment in the network environment of FIG. 1 according to various embodiments of the present disclosure.

FIG. 3 is a flowchart illustrating one example of functionality implemented as portions of an application executed in a computing environment in the network environment of FIG. 1 according to various embodiments of the present disclosure.

FIG. 4 is a flowchart illustrating one example of functionality implemented as portions of an application executed in a computing environment in the network environment of FIG. 1 according to various embodiments of the present disclosure.

FIG. 5 is a flowchart illustrating one example of functionality implemented as portions of an application executed in a computing environment in the network environment of FIG. 1 according to various embodiments of the present disclosure.

FIG. 6 is a flowchart illustrating one example of functionality implemented as portions of an application executed in a computing environment in the network environment of FIG. 1 according to various embodiments of the present disclosure.

### DETAILED DESCRIPTION

Disclosed are various approaches for integrating the simple certificate enrollment protocol (SCEP) into a device management system. Client devices can authenticate themselves with a predefined SCEP server or service. Client devices can then provide to the SCEP server or service cryptographic public keys from key pairs generated by the client device. The SCEP server or service can then issue a certificate to the client device that is signed by a certificate issued to the SCEP server or service. The client device can use the issued certificate to sign additional authentication credentials generated by the client device itself, allowing third-parties to verify that the identity of the client device has been validated by the SCEP service even though the authentication credentials are generated and signed by the client device.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

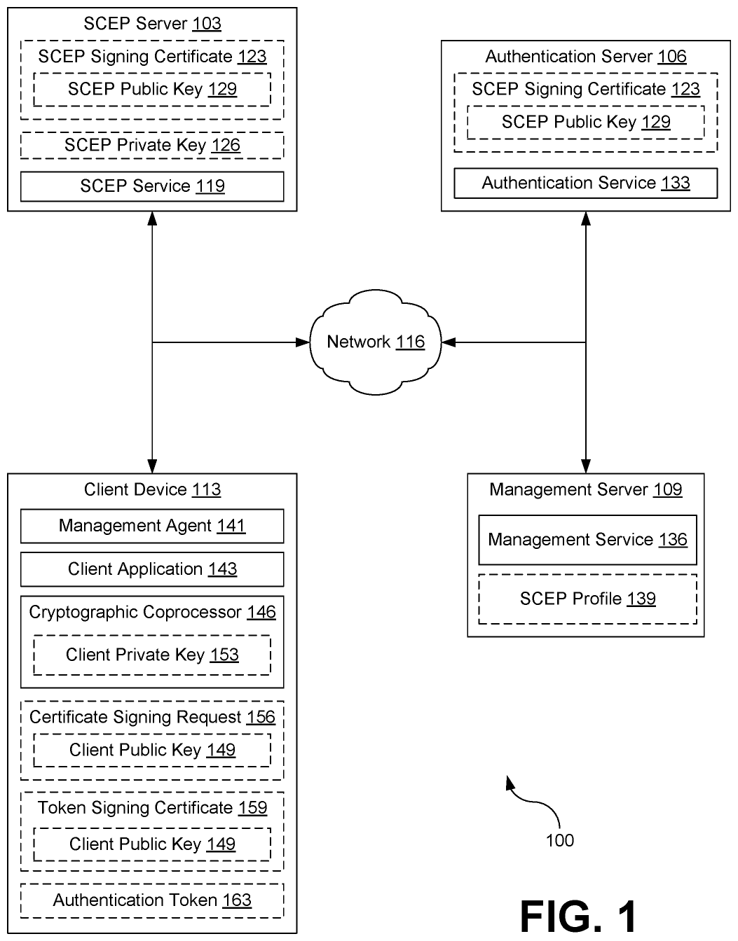

FIG. 1 depicts a network environment 100 according to various embodiments. The network environment 100 can include a simple certificate enrollment protocol (SCEP) server 103, an authentication server 106, a management server 109, and a client device 113, which can be in data communication with each other via a network 116.

The network 116 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 116 can also include a combination of two or more networks 116. Examples of networks 116 can include the Internet, intranets, extranets, virtual private networks (VPNs), and similar networks.

Each of the SCEP server 103, authentication server 106, and/or management server 109 can include one or more computing devices that include a processor, a memory, and/or a network interface. These computing devices can be configured to perform computations on behalf of other computing devices or applications. As another example, such computing devices can host and/or provide content to other computing devices in response to requests for content. Such computing devices can be located in a single installation or can be distributed among many different geographical locations. In some implementations, one or more of the SCEP server 103, authentication server 106, and/or management server 109 may be configured as virtual machines hosted by one or more host machines (e.g., in a hosted or cloud computing environment).

The SCEP server 103 can be used to execute a SCEP service 119. In order to implement the SCEP service 119, the SCEP server 103 can also store a SCEP signing certificate 123 and a SCEP private key 126. The SCEP signing certificate 123 can include a respective SCEP public key 129 for the SCEP private key 126. Although stored locally on the SCEP server 103, the SCEP signing certificate 123 can also be distributed to other computing devices or cached by other applications, as discussed later.

The SCEP service 119 can be executed to provide a scalable approach for issuing certificates to other application or devices. Accordingly, the SCEP service 119 can be configured to implemented and/or comply with one or more versions of the simple certificate enrollment protocol. To issue new certificates (e.g., in response to certificate signing requests (CSRs)), the SCEP service 119 may create a certificate and sign the certificate with the SCEP private key 126. The SCEP service 119 can use the SCEP public key 129 of the SCEP signing certificate 123 to validate the signature to third-parties to prove that the certificate was issued by the SCEP service 119. However, the SCEP signing certificate 123 can also be stored locally by other computing devices or applications to allow for local validation of the certificate issued by the SCEP service 119.

The authentication server 106 can be used to execute the authentication service 133. In some implementations, a copy of the SCEP signing certificate 123 and SCEP public key 129 can also be stored or cached by the authentication server 106.

The authentication service 133 can be executed to authenticate the identity of users of client devices 113. Authentication services 113 can be used in various contexts, such as authenticating users of websites or web-applications, authenticating users attempting to login to or access networks or network resources, etc. Examples of authentication services 113 include MICROSOFT ACTIVE DIRECTORY services that authenticate users in an ACTIVE DIRECTORY domain, KERBEROS services, remote authentication dial-in user service (RADIUS) services, OAUTH services, etc.

The management server 109 can be used to execute the management service 136. The management server 109 can also store one or more SCEP profiles 139, which can be distributed to client devices 113 by the management service 136 in response to enrollment by the client device 113 with the management service 136.

The management service 136 can administer the operation of client devices 113 that are registered or otherwise enrolled with the management service 136. To this end, the management service 136 can also provide mechanisms for a client device 113 to enroll or otherwise register with the management service 113. The management service 136 can also install or cause to be installed various applications on the client device 113 or for various configuration settings of the client device 113 to be set to a specified value. For instance, the management service 136 could configure an enrolled or registered client device 113 to use a SCEP service 119 specified in a SCEP profile 139 to obtain certificates. This could be done, for example, by providing the SCEP profile 139 to a management agent installed on the client device 113, which could read or interpret the SCEP profile 139 and configure the client device 113 based on the values specified in the SCEP profile 139.

The SCEP profile 139 can contain information about the SCEP server 103 and/or SCEP service 119 that a client device 113 should use for obtaining cryptographic certificates. For example, the SCEP profile 139 can include information such as the network address (e.g., internet protocol (IP) address, uniform resource locator (URL), or fully qualified domain name (FQDN)) of the SCEP server 103 or SCEP service 119. The SCEP profile 139 can also include information for how a client device 113 can authenticate itself with the SCEP service 119. This could include, for example, a seed for a one-time password generator to allow the client device 113 to generate one-time passwords for authentication with the SCEP service 119; an authentication certificate for use in a challenge-response handshake with the SCEP service 119; or other types of authentication or instructions.

The client device 113 is representative of a plurality of client devices 113 that can be coupled to the network 116. The client device 113 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, B1uRay® players, digital video disc (DVD) players, set-top boxes, and similar devices), a videogame console, or other devices with like capability. The client device 113 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 113 or can be connected to the client device 113 through a wired or wireless connection.

The client device 113 can be configured to execute various applications. These applications can include a management agent 141 and one or more client applications 143.

The management agent 141 can be executed to register or enroll the client device 113 with the management service 136 and to implement or enforce compliance with various commands or instructions provided by the management service 136. For example, the management agent 141 could provide user credentials (e.g., a username and password, one-time password, and/or certificate, etc.) to the management service 136. For example, the management agent 141 may be configured to regularly contact the management service 136 to provide status updates on the operation, state, or configuration of the client device 113 and retrieve commands from the management service 136 to implement on the client device 113. This can include, for example, retrieving or receiving a SCEP profile 139 from the management service 136 and interacting with a SCEP service 119 specified in the SCEP profile 139 in a manner defined in the SCEP profile 139.

The client application 143 can be executed by a client device 113 to access network content. To this end, the client application 113 can include a browser, a dedicated application, or other executable, and may generate a user interface such as web page, an application screen, or other user mechanism for obtaining user input The client device 113 can be configured to execute applications beyond the client application 143 such as email applications, social networking applications, word processors, spreadsheets, or other applications.

The client device 113 can also have a cryptographic coprocessor 146 installed. The cryptographic coprocessor 146 can represent a physical or emulated dedicated microcontroller that secures hardware using integrated cryptographic keys and provides various cryptographic operations. One example of a cryptographic coprocessor 146 includes those embodied as an application specific integrated circuit (ASIC), which may be unalterable after it is manufactured. Another example of a physical cryptographic coprocessor 146 can include a programmable chip or chipset with programmable firmware that implements the functions provided by the cryptographic coprocessor 146. Accordingly, one example of a cryptographic coprocessor 146 can be a microcontroller that implements a version of the trusted platform module (TPM) standard, which may be referred to as a TPM chip or TPM module. Although the cryptographic coprocessor 146 may be preferentially implemented in hardware (e.g., as an ASIC or a firmware-based solution) to prevent tampering with or circumvention of the cryptographic coprocessor 146, the functionality of the cryptographic coprocessor 146 can be implemented in software on those client devices 106 that lack a hardware-based cryptographic coprocessor 146.

The cryptographic coprocessor 146 can perform various cryptographic functions or operations on behalf of the client device 113 or applications executed by the client device 113. For example, the cryptographic coprocessor 146 may generate random numbers using a pseudorandom number generator (PRNG) or true random number generator (TRNG) included in the cryptographic coprocessor 146. As another example, the cryptographic coprocessor 146 can securely generate cryptographic keys or key-pairs, including symmetric encryption keys and asymmetric encryption key-pairs (such as the client public key 149 and the client private key 153). The cryptographic coprocessor 146 can also securely store one or more of these generated keys in a secure memory area provided by the cryptographic coprocessor 146, such as the client private key 153. The cryptographic coprocessor 146 can also encrypt or decrypt data using a cryptographic key generated by or imported into the cryptographic coprocessor 146. As another example, the cryptographic coprocessor 146 can also generate a hash of the current state of the hardware and software configuration of the client device 106, which can allow for remote attestation of the identity of the client device 106 or user of the client device 106.

The client public key 149 and the client private key 153 represent respective public and private keys of a public-key encryption keypair. They may be generated by the client device 113 (e.g., through the use of the cryptographic coprocessor 146) or imported into or installed on the client device 113 (e.g., by a user configuring his or her device). The client public key 149 and client private key 153 can be used for various cryptographic operations as described in this application.

The certificate signing request 156 can be used to request certificates from certificate authorities (CAs) or certificate issuing services. For example, the certificate signing request 156 could be used to request a token signing certificate 159 to be issued by the SCEP service 119. The certificate signing request 156 can include various types of information, such as the public key to be included in the issued certificate (e.g., the client public key 149) and other information specified by the SCEP profile 139. For example, the certificate signing request 156 could also include authentication information, such as a one-time password, cryptographic challenge generated by a certificate provided by the management service 136, or other authentication credential.

The token signing certificate 159 can be used to generate cryptographic signatures for authentication tokens 163. Because the token signing certificate 159 is issued by the SCEP service 119, it can be cryptographically signed by the SCEP service 119. Accordingly, any entity that can verify the signature of the token signing certificate 159 by the SCEP service 119 may be able to conclude that the token signing certificate 159 is a valid certificate. Therefore, any cryptographic signature issued for an authentication token 163 by the token signing certificate 159 can also be considered to be a valid signature.

The authentication token 163 can be any token that can be used to authenticate the client device 113 or client application 143 with an authentication service 133. This could include any type of ticket, password, one-time password, or other string of binary data or alphanumeric characters, etc. One example of an authentication token 163 can include a token that complies with a version of the JavaScript Object Notation (JSON) Web Token (JWT). The authentication token 163 could be used as part of any authentication scheme, such as a KERBEROS based authentication (e.g., ACTIVE DIRECTORY), OAUTH based authentication scheme, etc.

Next, a general description of the operation of the various components of the network environment 100 is provided. Although the following discussion provides an example of the operation of, and interactions between, various components, other implementations may utilize the various components in other manners.

To begin, a client device 113 can attempt to register or enroll with the management service 136. For example, the client device 113 may provide the username and credentials of a user is authorized to enroll the client device 113. In response to the management service 136 verifying the user credentials, the management service 136 may begin to configure the client device 113 to bring it into compliance with one or more policies.

For example, the management service 136 may provide a management agent 141 to the client device 113 for installation on the client device 113. The management agent 141 could then retrieve a copy of the SCEP profile 139 from the management service 136. The management service 136 may send various applications to the management agent 141 for installation. Likewise, the management service 136 could also provide various configuration files to the management agent 141 to read in order to set the values of various settings of the client device 113 to approved values.

The client device 113 can also generate a respective key pair that includes both a client public key 149 and a client private key 153, which may be initiated by the management agent 141 in some implementations. Client devices 113 which contain a cryptographic coprocessor 146 can use the cryptographic coprocessor 146 to generate the client public key 1349 and the client private key 153. These client devices 113 can also store the client private key 153 in the cryptographic coprocessor 146 to prevent unintended disclosure or compromise of the client private key 153.

The management agent 141 can then generate a certificate signing request 156 to send to the SCEP service 119. The certificate signing request 156 could be created in order for the client device 113 to obtain a token signing certificate 159. Accordingly, the certificate signing request 156 could include the client public key 149 that will be used for the token signing certificate 159. The certificate signing request 156 could also include additional information specified by the SCEP profile 139, such as authentication credentials that the SCEP service 119 would need to validate or authentication the client device 113 or user of the client device 113.

The management agent 141 could then send the certificate signing request 156 to the SCEP service 119 specified by the SCEP profile 139 that the management service 136 provided to the client device 113. In response, the SCEP service 119 can authenticate the client device 113 or user of the client device 113 and/or otherwise validate the certificate signing request 156. One authenticated or otherwise validated, the SCEP service 119 can create the token signing certificate 159. The SCEP service 119 can then sign the token signing certificate 159 with the SCEP private key 126 and return the signed token signing certificate 159 to the client device 113.

Subsequently, a client application 143 can attempt to authenticate with the authentication service 133 using an authentication token 163. To prove that the authentication token 163 was generated by the client device 113, the client application 143 can cause the cryptographic coprocessor 146 to generate a signature for the authentication token 153 using the client private key 153. The authentication token 163 and the token signing certificate 159 can then be presented to the authentication service 133 to authenticate the client application 143 executing on the client device 113.

The authentication service 133 can then validate the authentication token 163. For example, the authentication service 133 could use the client public key 149 included in the token signing certificate 159 to verify that the signature of the authentication token 163 was created with the client private key 153 stored within the cryptographic coprocessor 146 of the client device 113. The authentication service 113 could then use the SCEP signing certificate 123 to verify that the token signing certificate 159 was issued by the SCEP service 119. Once the chain of certificates is verified, the authentication service 133 could then evaluate whether or not the client application 143 should be granted access to the requested resource based on the authentication token 163

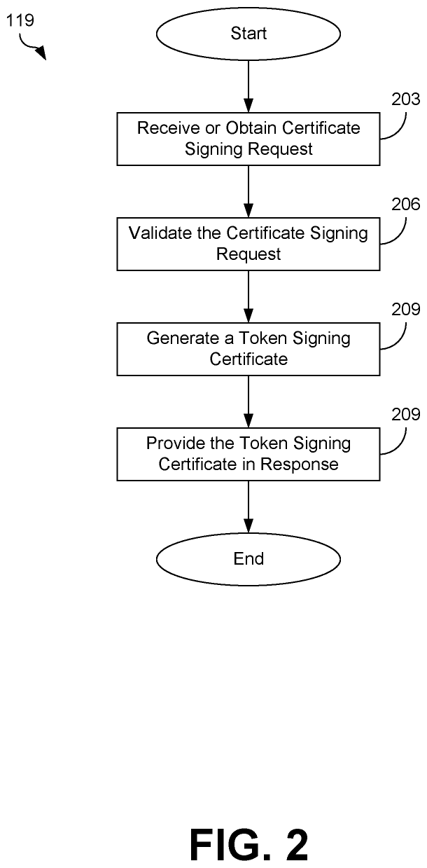

Referring next to FIG. 2, shown is a flowchart that provides one example of the operation of a portion of the SCEP service 119. The flowchart of FIG. 2 provides merely an example of the many different types of functional arrangements that can be employed to implement the operation of the depicted portion of the SCEP service 119. As an alternative, the flowchart of FIG. 2 can be viewed as depicting an example of elements of a method implemented within the network environment 100.

Beginning at step 203, the SCEP service 119 can receive a certificate signing request 156 from a client device 113. The certificate signing request 156 could be received from a management agent 141 executing on the client device 113 or from a client application 143 executing on the client device 113, depending on the particular situation or implementation.

Next at step 206, the SCEP service 119 can validate the certificate signing request 156. For example, the SCEP service 119 could determine that the certificate signing request 156 contains one or more authentication credentials, such as a username and password, a one-time password or credential, a pre-shared key or secret, etc. The SCEP service 119 could then validate these against a pre-existing database of user credentials (e.g., a directory service containing usernames and passwords, a one-time password generator, a copy of a pre-shared key or secret, etc.). If the certificate signing request 156 is valid, then the process would continue to step 209.

Then at step 209, the SCEP service 119 can generate a token signing certificate 159. For example, the SCEP service 119 could include the client public key 149 in the certificate signing request 156 and any other identifying information included in the certificate signing request 156 in the token signing certificate. The SCEP service 119 could then generate a signature for the token signing certificate 159 using the SCEP private key 126. The signature generated using the SCEP private key 126 could also be inserted into the token signing certificate 159, thereby allowing any computing device or service with access to the SCEP signing certificate 123 or SCEP public key 129 the ability to verify that the token signing certificate 159 was issued by the SCEP service 119 by verifying the signature generated for the token signing certificate 159.

Moving on to step 213, the SCEP service 119 can provide the token signing certificate 159 to the client device 113. For example, the SCEP service 119 can provide the token signing certificate 159 in response to the certificate signing request 156 received at step 203.

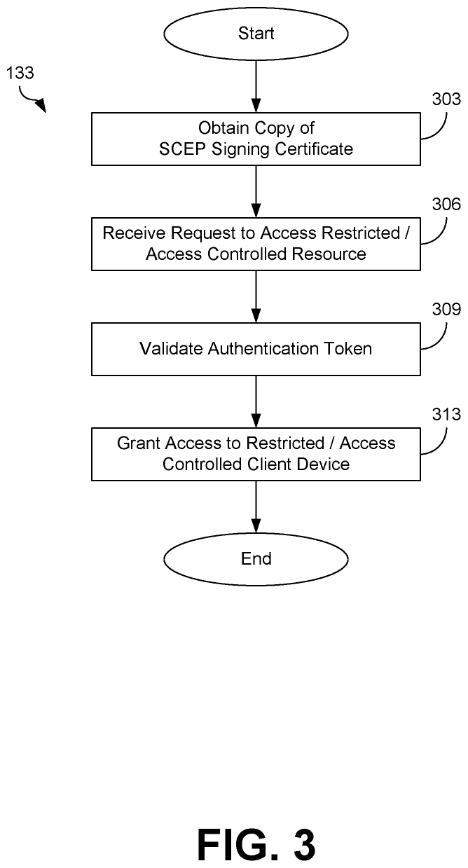

Referring next to FIG. 3, shown is a flowchart that provides one example of the operation of a portion of the authentication service 133. The flowchart of FIG. 3 provides merely an example of the many different types of functional arrangements that can be employed to implement the operation of the depicted portion of the authentication service 133. As an alternative, the flowchart of FIG. 3 can be viewed as depicting an example of elements of a method implemented within the network environment 100.

Beginning with step 303, the authentication service 133 can obtain a copy of the SCEP signing certificate 123 from the SCEP service 119. For example, the authentication service 133 could send a request to the SCEP service 119 for the SCEP signing certificate 123 and receive a copy in response. As another example, the SCEP service 119 could send a copy of the SCEP signing certificate 123 upon creation of the SCEP signing certificate 123. In these implementations, the authentication service 133 may already be known to the SCEP service 119.

Later, at step 306, the authentication service 133 can receive a request from a client application 143 to access a restricted or access-controlled resource. For example, the authentication service 133 could receive a request from a web-browser to access a web-page, a request from a virtual private network (VPN) client to access a VPN network, a request from an email client to access an email account, etc. The access request can include access credentials, such as a copy of a token signing certificate 159, an authentication token 163, and a signature for the authentication token 163.

Then, at step 309, the authentication service 133 can validate the authentication token 163 included in the request to access the restricted or access-controlled resource. For example, the authentication service 133 can first validate the signature for the authentication token 163 received at step 306 using the token signing certificate 159 received at step 306. If the signature is valid, then the authentication service 133 can conclude that the client private key 153 of the client device 113 was used to sign the authentication token 163 and, therefore, that the authentication token 163 originated from the client device 113. Assuming the signature is valid, the authentication service 133 can then use the SCEP signing certificate 123 to validate the signature of the token signing certificate 159. If the signature of the token signing certificate 159 is valid, then the authentication service 133 can conclude that the authentication token 163 provided at step 306 comes from a client device 113 that has been verified by the SCEP service 119.

It should be noted, however, that in some implementations step 309 could be implemented by having the SCEP service 119 perform the validation of the authentication token 163. In these alternative implementations, after the authentication service 133 validates the signature of the authentication token 163, the authentication service 133 could forward the token signing certificate 159 to the SCEP service 119. The SCEP service 119 could then use the SCEP signing certificate 123 to validate the signature of the token signing certificate 159 and report the results to the authentication service 133. If the signature of the token signing certificate 159 is valid, then the authentication service 133 can conclude that the authentication token 163 provided at step 306 comes from a client device 113 that has been verified by the SCEP service 119.

Next, at step 313, the authentication service 133 can grant access to the restricted or access-controlled resource. For example, the authentication service 133 could provide a key or token to a web-browser that allows the web-browser to access a website. As another example, the authentication service 133 could grant a ticket or token to a VPN client on the client device 113 to allow the VPN client to access a VPN server or service.

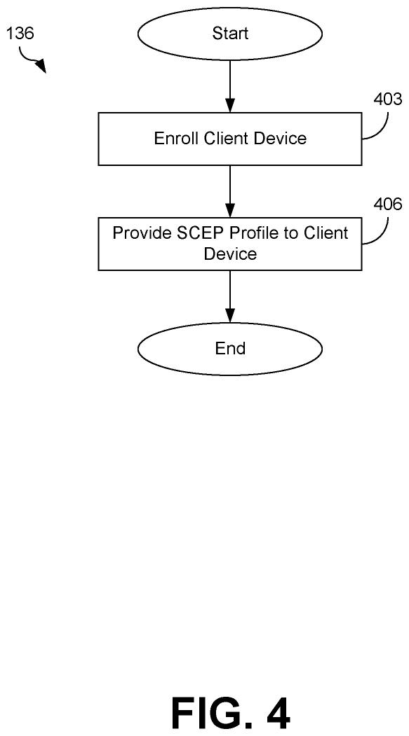

Referring next to FIG. 4, shown is a flowchart that provides one example of the operation of a portion of the management service 136. The flowchart of FIG. 4 provides merely an example of the many different types of functional arrangements that can be employed to implement the operation of the depicted portion of the management service 136. As an alternative, the flowchart of FIG. 4 can be viewed as depicting an example of elements of a method implemented within the network environment 100.

Beginning with block 403, the management service 136 enrolls a client device 113 with the management service 136. For example, the management service 136 can obtain an enrollment request comprising authentication information that identifies and authenticates the user of the client device 113. After verifying that the user of the client device 113 is authorized to register the client device 113 with the management service 136, the management service 136 can add the client device to a list of enrolled devices and provide a management agent 141 to the client device 113 for installation on the client device 113.

At block 406, in response to enrollment, the management service 136 can provide a SCEP profile 139 to the management agent 141 installed on the client device. This could be done in response to receiving a request from the management agent 141 for additional data or configuration profiles. Alternatively, the SCEP profile 139 could be provided to the management agent 141 without waiting for a request.

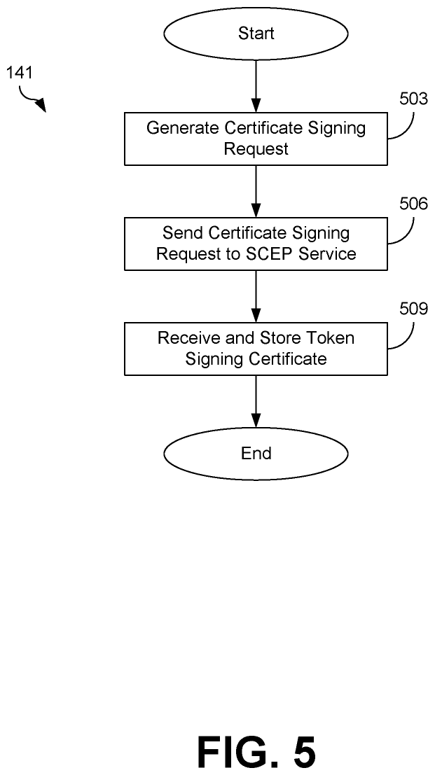

Referring next to FIG. 5, shown is a flowchart that provides one example of the operation of a portion of the management agent 141. The flowchart of FIG. 5 provides merely an example of the many different types of functional arrangements that can be employed to implement the operation of the depicted portion of the management agent 141. As an alternative, the flowchart of FIG. 5 can be viewed as depicting an example of elements of a method implemented within the network environment 100.

Beginning at step 503, the management agent 141 can generate a certificate signing request 156. First, the management agent 141 could analyze or review the SCEP profile 139 provided by the management service 136 to identify the requirements of the SCEP service 119, such as authentication mechanisms needed to authenticate the certificate signing request 156 with the SCEP service 119. For example, if the SCEP service 119 required the use of a one-time password that complied with a particular algorithm, protocol, or scheme, the management agent 141 could generate an appropriate one-time password and include it in the certificate signing request 156. The management agent 141 could also include the client public key 149 and any identifying information about the client device 113 or the user of the client device 113 in the certificate signing request 156.

Then, at step 506, the management agent 141 can send the certificate signing request 156 to the SCEP service 119. For example, the management agent 141 could use the network address specified in the SCEP profile 139 as the destination for the certificate signing request 156. In response, the management agent 141 can, at step 509, receive and store a copy of a token signing certificate 159 generated by the SCEP service 119.

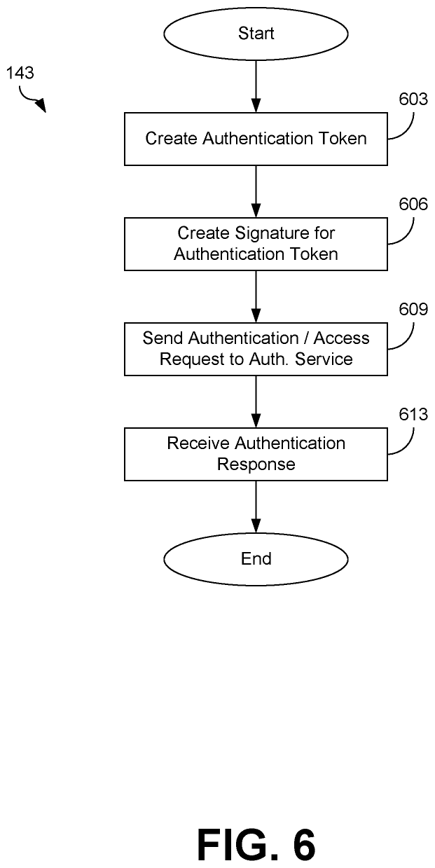

Referring next to FIG. 6, shown is a flowchart that provides one example of the operation of a portion of the client application 143. The flowchart of FIG. 6 provides merely an example of the many different types of functional arrangements that can be employed to implement the operation of the depicted portion of the client application 143. As an alternative, the flowchart of FIG. 6 can be viewed as depicting an example of elements of a method implemented within the network environment 100.

Beginning with step 603, the client application 143 can create an authentication token 163 for use to access a resource protected by the authentication service 133. The authentication token 163 can be generated according to various protocols (e.g., a JSON Web Token).

After creating the authentication token 163, the client application 143 can create a signature for the authentication token 163 at step 606. For example, the client application 143 could use the client private key 153 to generate a signature for the authentication token 163. This could be done by the client application 143 itself, or the client application 143 could cause the cryptographic coprocessor 146 to generate the signature using the client private key 153.

Then, at step 609, the client application 143 can send an authentication or access request to the authentication service 133. The access or authentication request can include the authentication token 163, the signature generated for the authentication token 163, and a copy of the token signing certificate 159 to allow the authentication service 133 to validate the signature for the authentication token 163.

Subsequently, at step 613, the client application 143 can receive an authentication response. If the authentication response is positive, indicating that the authentication service 133 successfully validated the client application 143 using the authentication token 163, then the client application 143 may subsequently access the resource protected by the authentication service 133.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
send a certificate signing request (CSR) for a token signing certificate to a simple certificate enrollment protocol (SCEP) server;
receive the token signing certificate from the SCEP server;
generate an authentication token that authenticates a user of the computing device with an authentication service;
sign the authentication token with the token signing certificate to create a signed authentication token; and
send the signed authentication token to the authentication service to authenticate the user of the computing device with the authentication service.

2. The system of claim 1, wherein the computing device further comprises a cryptographic coprocessor and the machine-readable instructions further cause the computing device to at least:
generate, with the cryptographic coprocessor, a key-pair comprising a public key and a respective private key;
store the private key in the cryptographic coprocessor; and
wherein the CSR comprises the public key.

3. The system of claim 1, wherein the machine-readable instructions further cause the computing device to at least:
generate a one-time authentication credential associated with the user of the computing device; and
wherein the CSR further comprises the one-time authentication credential.

4. The system of claim 1, wherein the machine-readable instructions further cause the computing device to at least receive a SCEP profile specifying that the SCEP server requires a one-time authentication credential to authenticate the CSR.

5. The system of claim 4, wherein the machine-readable instructions further cause the computing device to:
register the computing device with a management service; and
receive the SCEP profile from the management service in response to registration with the management service.

6. The system of claim 1, wherein the machine-readable instructions further cause the computing device to receive a response from the authentication service, the response indicating that the computing device has been authenticated based at least in part on the signed authentication token.

7. The system of claim 1, wherein the authentication token and the signed authentication token comply with a version of the JavaScript Object Notation (JSON) format.

8. A method, comprising:
sending a certificate signing request (CSR) for a token signing certificate to a simple certificate enrollment protocol (SCEP) server;
receiving the token signing certificate from the SCEP server;
generating an authentication token that authenticates a user of a computing device with an authentication service;
signing the authentication token with the token signing certificate to create a signed authentication token; and
sending the signed authentication token to the authentication service to authenticate the user of the computing device with the authentication service.

9. The method of claim 8, further comprising generating a key-pair comprising a public key and a respective private key, wherein the CSR comprises the public key.

10. The method of claim 8, further comprising:
generating a one-time authentication credential associated with the user of the computing device; and
wherein the CSR further comprises the one-time authentication credential.

11. The method of claim 8, further comprising receiving a SCEP profile specifying that the SCEP server requires a one-time authentication credential to authenticate the CSR.

12. The method of claim 11, further comprising:
registering the computing device with a management service; and
receiving the SCEP profile from the management service in response to registration with the management service.

13. The method of claim 8, further comprising receiving a response from the authentication service, the response indicating that the computing device has been authenticated based at least in part on the signed authentication token.

14. The method of claim 8, wherein the authentication token and the signed authentication token comply with a version of the JavaScript Object Notation (JSON) format.

15. A system, comprising:
a computing device comprising a processor and a memory; and
machine-readable instructions stored in the memory that, when executed by the processor, cause the computing device to at least:
receive, from a client device, a certificate signing request (CSR) for a token signing certificate, the CSR comprising a public key;
verify an identity of a user of the client device;
issue the token signing certificate, wherein the token signing certificate is signed by a respective private key for a simple certificate enrollment protocol (SCEP) signing certificate; and
send the token signing certificate to the client device.

16. The non-transitory, computer-readable medium of claim 15, wherein the machine-readable instructions, when executed by the processor, further cause the computing device to at least provide the SCEP signing certificate to an authentication service.

17. The non-transitory, computer-readable medium of claim 15, wherein the SCEP signing certificate is provided to the authentication service in response to receipt of a request for the SCEP signing certificate from the authentication service.

18. The non-transitory, computer-readable medium of claim 15, wherein the machine-readable instructions, when executed by the processor, further cause the computing device to at least:
receive an authentication request for a token signed by the token signing certificate;
validate a signature for the token signing certificate with the SCEP signing certificate; and
return a response to the authentication request that the token signing certificate is valid.

19. The non-transitory, computer-readable medium of claim 15, wherein the machine-readable instructions that cause the computing device to verify the identity of the user of the client device further cause the computing device to at least:
identify an authentication credential included in the certificate signing request; and
validate the authentication credential in the certificate signing request.

20. The non-transitory, computer-readable medium of claim 19, wherein the authentication credential comprises a one-time password.
